(19) United States
(12) Patent Application Publication
(10) Pub. No.: US 2008/0026754 A1
(43) Pub. Date: Jan. 31, 2008

(54) CALL HANDOVER BETWEEN RADIO NETWORK SUBSYSTEMS

(75) Inventors: Yong-Hong Chang, Beijing (CN); Ke Lin, Hadrian District (CN); Zhong-Qing Song, Beijing (CN); Deng-Kun Xiao, Beijing (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/461,125

(22) Filed: Jul. 31, 2006

(51) Int. Cl. H04Q 7/20

(52) U.S. Cl. 455/436

(57) ABSTRACT

Before call handover between radio network subsystems (RNS's) of a radio access network, a serving radio network controller (RNC) of a first RNS determines the level of congestion in an Iur interface between the serving RNC and an RNC of a second RNS. If the Iur interface is determined to be congested when a call handover is required, the serving RNC uses the Iu interface with a core network of the radio access network to signal the core network to perform a call handover, and the core network uses the Iu interface with the RNC of the second RNS to signal the RNC of the second RNS to become a serving RNC for the call.

### BACKGROUND

A radio access network may be made up of a number of radio network subsystems (RNS's). For example, the UMTS Terrestrial Radio Access Network (UTRAN) is a radio access network that uses the Universal Mobile Telecommunication System (UMTS) protocol. In UTRAN, each RNS includes of a radio network controller (RNC) that controls a number of base station transceivers referred to as Node B's. Each Node B provides network access to user equipment (UE) in one or more geographical cells, and the RNC is responsible for the Node B handover decisions that require signaling to the user equipment (UE). The interface between an RNC and a base station transceiver (Node B) of the RNS controlled by the RNC is denoted by ‘Iub’.

Each RNS is connected via a logical interface (denoted as Iu) to a core network (such the GSM Phase 2+ core network or other telecommunication network). The UTRAN interface between the radio network controller (RNC) and the core network (CN) is denoted by ‘Iu’. The interface between a RNC and the packet-switched domain of the CN (Iu-PS) is used for packet switched data (using a serving GPRS support node (SGSN) for example) and the UTRAN interface between RNC and the circuit-switched domain of the CN (Iu-CS) is used for circuit switched data (using a mobile services switching center (MSC) for example).

The interface that interconnects RNC's together through a reference point is denoted by “Iur’. The Iur and Iu interfaces are both logical interfaces that can be implemented over any suitable transport network. The Iur may be a physical connection between RNS's.

On each connection between user equipment (UE) and the core network (CN), one RNC is designated as the serving RNC (SRNC). If a user moves from one RNS to another, a handover to a new RNC is required. This inter-RNC handover utilizes the Iur interface between the current serving RNC and the new RNC (sometimes called the drift RNC). However, the Iur interface may become congested. When this happens, new calls attempting handover will be dropped. Current specifications, such as the 3GPP specification, do not provide any relief mechanisms for this congestion, other than by releasing calls, reducing the data rate of current services, priority processing and preemption. These approaches do not result in any action in the interface itself.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a block diagram of a radio access network in a first mode of operation.

FIG. 2 is a block diagram of a radio access network in a second mode of operation, consistent with certain embodiments of the invention.

FIG. 3 is a flow chart of a method for call handover between subsystems in a radio access network, consistent with certain embodiments of the invention

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

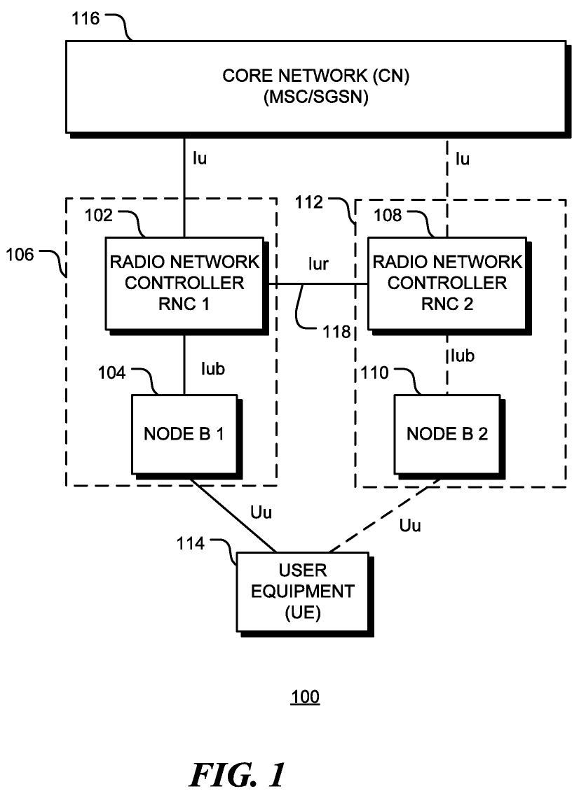

FIG. 1 is a block diagram of a radio access network in a first mode of operation. The radio access network 100 includes a radio access controller (RNC) 102 and a base station transceiver, or Node B, 104 of a first radio network subsystem (RNS) 106. The radio access network 100 includes additional radio network subsystems, such the system incorporating radio access controller (RNC) 108 and node B 110 of a second radio network subsystem 112. The radio network subsystems allow user equipment (UE) 114 of a mobile user to access a core network (CN) 116. The core network may, for example, use packet switching accessed by an SGSN element or circuit switching accessed by an MSC element.

Communication between the RNC's and the CN is provided by an interface denoted by ‘Iu’. Communication between the RNC's and the user equipment is provided by an interface denoted by ‘Uu’. Inter-RNC communication between the RNC's is provided by an interface denoted by ‘Iur’ (118 in FIG. 1).

In operation, an RNC controls handover of node B's as the user equipment moves between cells. When user equipment moves between radio network subsystems, it is necessary to perform a handover between RNC's. In prior systems, this handover requires communication between the RNC 102 currently handling the access (termed the server RNC or SRNC) and a new RNC 110 using the Iur interface 118 between them. In some situations, this interface may become congested. When the interface is congested, new calls attempting handover will be dropped. Current specifications, such as the 3GPP specification, do not provide any relief mechanisms for this congestion.

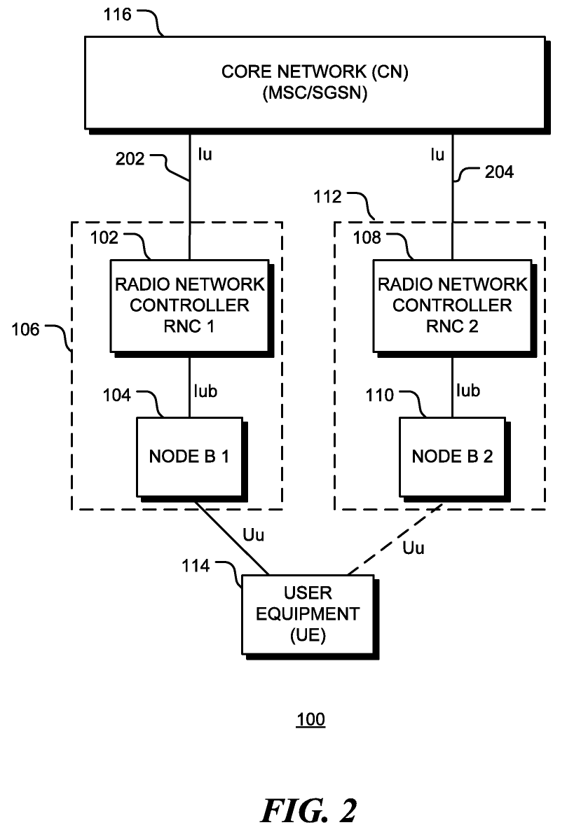

FIG. 2 is a block diagram of a radio access network in a second mode of operation. In the second mode of operation, signaling to perform the call handover between the first RNC 102 and the second RNC 108 is passed through the core network 116 when the Iur interface between the first and second RNC's is congested. Thus, the signaling is passed from the first RNC 102 to the CN 112 via the Iu interface 202 and then from the CN 116 to the second RNC 110 via the Iu interface 204.

In one embodiment, the serving RNC (102 in this example) monitors the Iur interface continuously to detect Iur congestion. When the Iur is congested, the handover signaling is redirected to the core network for relocation. This avoids further use of the congested Iur interface. For example, the serving RNC may redirect signaling for low priority calls when more than 80% of the total bandwidth of the interface is in use. The remaining 20% of bandwidth may be reserved for high priority calls requiring short handover times. Other congestion metrics may be used to determine when handover signaling redirection to the core network should occur and for which calls.

In a further embodiment, the serving RNC counts the number of handover attempts and redirects the handover signaling to the core network when a specified number of handover attempts is reached.

These approaches avoid lost calls due to Iur congestion and reduce handover failures.

Prior approaches for reducing Iur congestion include releasing calls, reducing the data rate of current services, priority processing and preemption. These approaches do not result in any action in the interface itself and do not make use of the Iu interface. The present approach provides congestion relief without loss of performance.

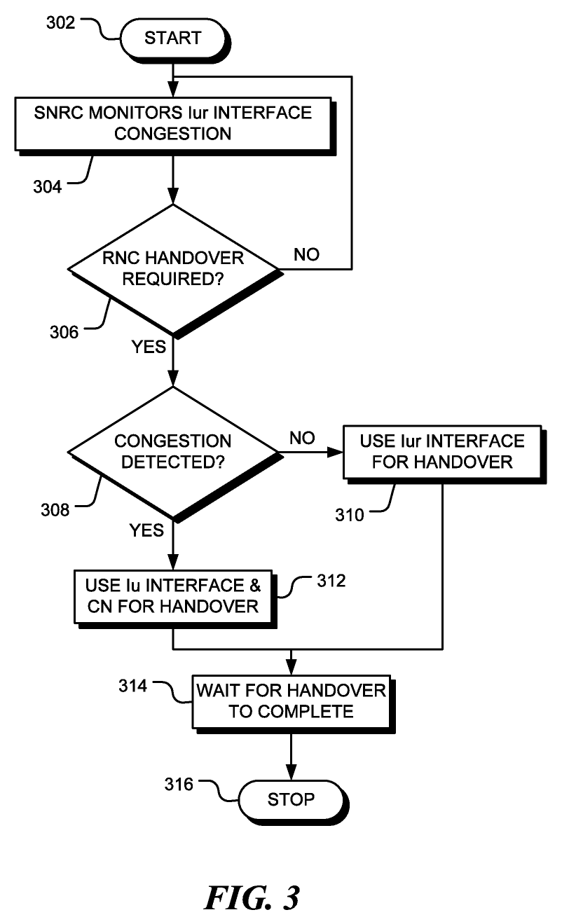

FIG. 3 is a flow chart of a method for call handover between subsystems in a radio access network, consistent with certain embodiments of the invention. Referring to FIG. 3, following start block 302, a serving RNC (SRNC) monitors an Iur interface for congestion at block 304. This may be achieved by monitoring bandwidth usage, the number of handovers, or a combination of these metrics. Other congestion metrics will be apparent to those of ordinary skill in the art. At decision block 306, a check is made to determine is an RNC handoff to a different radio network subsystem is required. If not, as depicted by the negative branch from decision block 306, the SRNC continues to monitor the interface for congestion. If a handoff to a different subsystem is required, as depicted by the positive branch from decision block 306, a decision is made at decision block 308 as to whether the Iur interface is congested. This decision may be dependent upon the priority of call or other characteristics of the call. For example, a higher level of congestion may be required before the Iur interface is deemed too congested for a high priority calls as compared to the level of congestion required for a low priority call. If the Iur interface is not too congested, as depicted by the negative branch from decision block 308, the Iur interface is used for the handover in the usual manner at block 310. However, if the Iur interface is judged to be too congested, as depicted by the positive branch from decision block 308, the handover signaling is redirected to the core network (CN) via the Iu interface and the core network signals the RNC of the new subsystem to become the serving RNC at block 312. At block 314, the serving RNC waits for the handover to be completed and then ends the call at termination block 316.

Those skilled in the art will appreciate that the program steps and associated data used to implement the embodiments described above can be implemented using disc storage as well as other forms of storage, such as, for example, Read Only Memory (ROM) devices, Random Access Memory (RAM) devices, optical storage elements, magnetic storage elements, magneto-optical storage elements, flash memory and/or other equivalent storage technologies without departing from the present invention. Such alternative storage devices should be considered equivalents.

The present invention, as described in embodiments herein, is implemented using a programmed processor, executing programming instructions that are broadly described above in flow chart form that can be stored on any suitable electronic storage medium. The programmed processor may be located in the RNC. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made without departing from the present invention. Such variations are contemplated and considered equivalent.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for call handover between radio network subsystems of a radio access network, the method comprising:
a serving radio network controller (RNC) of a first radio network subsystem (RNS) of the radio access network determining congestion in an Iur interface between the serving RNC and an RNC of a second RNS of the radio access network;
if the Iur interface is determined to be congested when handover of a call from the serving RNC of the first RNS to the RNC of the second RNS is required:
the serving RNC using an Iu interface with a core network of the radio access network to signal the core network to perform a call handover; and
the core network using an Iu interface with the RNC of the second RNS to signal the RNC of the second RNS to become a serving RNC for the call.

2. A method in accordance with claim 1, wherein the serving RNC of the first RNS of the radio access network determining congestion in the Iur interface between the serving RNC and the RNC of the second RNS comprises:
monitoring bandwidth usage of the Iur interface; and
determining the Iur interface to be congested if the bandwidth usage exceeds a threshold.

3. A method in accordance with claim 2, wherein the threshold is a fixed percentage of the maximum bandwidth of the interface.

4. A method in accordance with claim 2, wherein the threshold is dependent upon the priority of the call.

5. A method in accordance with claim 4, wherein the threshold is higher for high priority calls than for lower priority calls.

6. A method in accordance with claim 1, wherein the serving RNC of the first RNS of the radio access network determining congestion in the Iur interface between the serving RNC and the RNC of the second RNS comprises:
monitoring the number of handover attempts between the serving RNC and the RNC of the second RNS; and
determining the Iur interface to be congested if the number of handover attempts exceeds a specified threshold.

7. A method in accordance with claim 1, further comprising:
if handover of a call from the serving RNC of the first RNS to the RNC is required and the Iur interface is determined to be not congested:
the serving RNC using an Iur interface with the RNC of the second RNS to signal the RNC of the second RNS to become a serving RNC for the call.

8. A first radio network controller (RNC) operable to control a Node B transceiver in a first subsystem of a radio access network and route a call from user equipment to a core network, the RNC comprising:
an Iub interface to the Node B transceiver operable to receive the call from the user equipment;
an Iu interface to the core network operable to pass the call to the core network; and
an Iur interface to a second RNC of a second subsystem of the radio access network;
wherein, the first RNC is operable to handover the call to the second RNC using the Iur interface when call handover from the first subsystem to the second subsystem is required and the Iur interface is not congested, and wherein the first RNC is operable to handover the call to the second RNC using the Iu interface with the core network when call handover from the first subsystem to the second subsystem is required and the Iur interface is congested.

9. A first radio network controller (RNC) in accordance with claim 8, further operable to monitor the bandwidth usage of the Iur interface.

10. A first radio network controller (RNC) in accordance with claim 8, further operable to count handover attempts to determine congestion on the Iur interface.

11. A first radio network controller (RNC) in accordance with claim 8, further operable to determine if the Iur interface is congested.

12. A first radio network controller (RNC) in accordance with claim 11, wherein the Iur interface is determined to be congested if bandwidth usage exceeds a threshold level.

13. A first radio network controller (RNC) in accordance with claim 11, wherein the threshold level is greater for high priority calls than for low priority calls.

14. A computer readable medium containing programming instructions that, when executed on a processor of a radio network controller (RNC) of a first subsystem of a radio access network, control the RNC of the first subsystem to:
monitor congestion in an Iur interface between the RNC of the first subsystem and an RNC of a second subsystem of the radio access network; and
if a call handover from the RNC of the first subsystem to the RNC of the second subsystem is required:
transmit a signal over an Iu interface to a core network of the radio access network, instructing the core network to participate in the call handover with a core network if the Iur interface is determined to be congested; and
transmit a signal over the Iur interface to the RNC of the second subsystem, instructing the RNS of the second subsystem to participate in the call handover if the Iur interface is determined to be not congested.

15. A computer readable medium in accordance with claim 14, wherein controlling the RNC of the first subsystem to monitor congestion in the Iur interface comprises:
monitoring bandwidth usage of the Iur interface; and
determining the Iur interface to be congested if the bandwidth usage exceeds a threshold.

16. A computer readable medium in accordance with claim 15, wherein the threshold is a fixed percentage of the maximum bandwidth of the interface.

17. A computer readable medium in accordance with claim 15, wherein the threshold is higher for high priority calls than for lower priority calls.

18. A computer readable medium in accordance with claim 14, wherein controlling the RNC of the first subsystem to monitor congestion in the Iur interface comprises:
monitoring the number of handover attempts between the RNC of the first subsystem and the RNC of the second subsystem; and
determining the Iur interface to be congested if the number of handover attempts exceeds a specified threshold.
